(19) United States
(12) Patent Application Publication
(10) Pub. No.: US 2026/0328342 A1
(43) Pub. Date: Oct. 22, 2026

(54) PRESSURE VESSEL STRUCTURE

(71) Applicant: HONDA MOTOR CO., LTD., Tokyo (JP)

(72) Inventors: Shoki HASEGAWA, Wako-shi (JP); Toshihiko KANEZAKI, Wako-shi (JP); Hiroshi MATSUSHIMA, Tokyo (JP); Yukio MIYAKOSHI, Tokyo (JP)

(21) Appl. No.: 19/465,623

(22) Filed: Jan. 30, 2026

(30) Foreign Application Priority Data
Feb. 17, 2025 (JP) 2025-023785

(51) Int. Cl. F17C 1/16

(52) U.S. Cl. CPC F17C 1/16; F17C 2201/0109; F17C 2203/0604; F17C 2203/066; F17C 2205/0305

(57) ABSTRACT

A cylindrical synthetic resin liner having a storage part therein includes a dome part for mounting a mouth ring at an end in an axial direction L, a groove formed in a recessed shape at a center in a radial direction of the dome part to mount the mouth ring, and a locking part 12 projected from a connecting part of the dome part and the groove to lock the mouth ring. The locking part includes a first wall extending from the dome part toward the center in the radial direction, a second wall extending from the groove toward an outer side in the axial direction, and a top where the first wall and the second wall abut against each other. The first wall and the second wall are respectively increased in thickness toward the top. Further, a lightening part is provided on a back surface side of the top.

### CROSS-REFERENCE TO RELATED APPLICATION

The present application claims the benefit of priority to Japanese Patent Application No. 2025-023785 filed on Feb. 17, 2025, the disclosures of all of which are hereby incorporated by reference in their entireties.

### TECHNICAL FIELD

The present invention relates to a pressure vessel structure.

### BACKGROUND

In recent years, research and development has been conducted on fuel cells that contribute to energy efficiency, so that more people can secure affordable, reliable, sustainable, and advanced access to energy.

Conventionally, a pressure vessel structure of a cylindrical shape used for a fuel cell includes a liner made of resin and a reservoir part therein, and dome parts provided at axial ends in an axial direction of the liner. Each dome part is attached to a mouth ring for connecting an external pipe toward outside in the axial direction.

A reinforcing layer is formed by winding a fiber member containing a curable resin for reinforcement around the liner (for example, Japanese Patent No. 6678460).

### SUMMARY

However, in the conventional pressure vessel structure, when the fiber member is wound around the injection molded liner, the liner is rotated by turning the mouth rings. Accordingly, the fiber member is wound around the liner while being pulled with a desired strength. Therefore, if the mouth rings and the liner slip with each other, the fiber member cannot be fixed while being pulled with the desired strength.

Further, if a protrusion for locking the mouth ring so as not to rotate is formed on the liner, there is a risk that flow disturbance occurs in a resin material flowing into a part where the protrusion is formed. If a temperature of the injected resin material is uneven, plastic distortion may occur when the resin material is cured, and there is room for further improvement.

The present invention is intended to provide a pressure vessel structure capable of improving flow disturbance at the time of molding and reducing plastic distortion. The present invention is directed to contribute to energy efficiency.

To solve the problem, a pressure vessel structure of the present invention includes a cylindrical synthetic resin liner having a reservoir part therein and a mouth ring provided at an end in an axial direction of the liner. The liner includes a dome part provided at the end in the axial direction of the liner, a groove formed in a concave shape at a center in a radial direction of the dome part to which the mouth ring is mounted, and a locking part that is provided to protrude from a connecting part between the dome part and the groove to lock the mouth ring. The locking part includes a first wall extending from the dome part toward a center in the radial direction, a second wall extending from the groove toward an outer side in the axial direction, and a top where the first wall and the second wall are abutted against each other. The first wall has a thickness that increases toward the top. The second wall has a thickness that increases toward the top. Further, a lightening part is provided on a back surface side of the top.

The present invention provides a pressure vessel structure capable of improving flow disturbance at the time of molding and reducing plastic distortion. The present invention contributes to energy efficiency.

### BRIEF DESCRIPTION OF THE DRAWINGS

FIG. 1 is a vertical sectional view along an axial direction to explain an entire configuration of a pressure vessel structure according to an embodiment of the present invention;

FIG. 2 is an enlarged sectional view of a part II of FIG. 1, showing a configuration of a main part of the pressure vessel structure;

FIG. 3 is a perspective view showing a mouth ring mounted on a dome part in the pressure vessel structure;

FIG. 4 is a sectional view taken along a line IV-IV in FIG. 3, showing a configuration of a locking part;

FIG. 5 is an enlarged sectional view of a V-section in FIG. 2 for comparing thicknesses of a flat part, an inclined part, and a connecting part.

### DETAILED DESCRIPTION

Next, a description is given of an embodiment of the present invention with reference to accompanying drawings as appropriate. In the description, the same members are denoted by the same reference numerals, and the same descriptions are omitted.

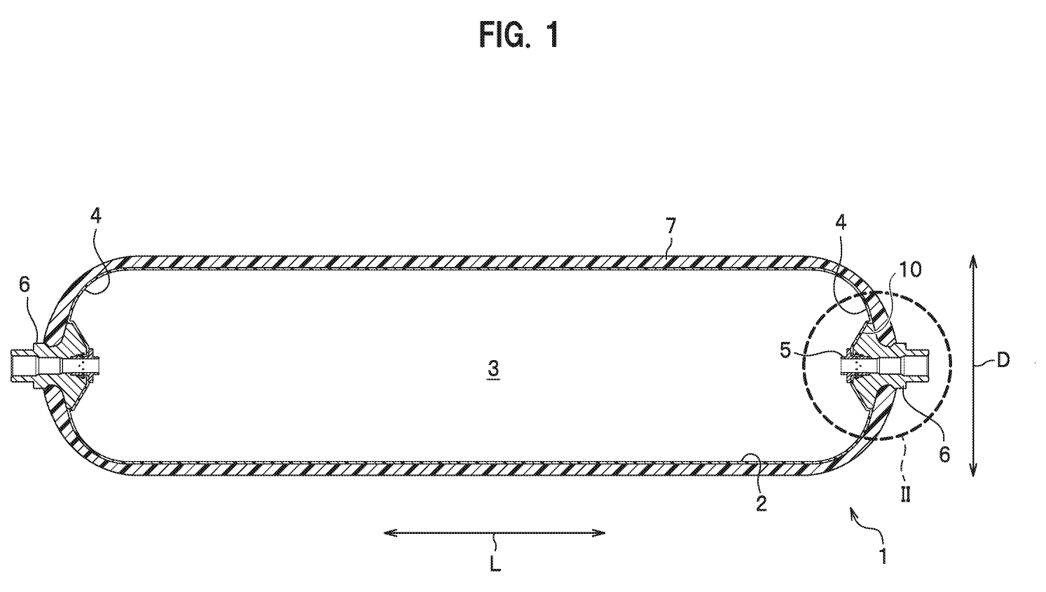

FIG. 1 illustrates a pressure vessel structure according to the embodiment.

A pressure vessel 1 is mounted on a fuel cell vehicle or a natural gas vehicle, and is used as a filling vessel for high-pressure hydrogen gas or natural gas.

The pressure vessel 1 includes a resin liner 2 in a cylindrical shape having a storage part 3 therein, and dome parts 4 respectively provided at both ends in an axial direction of the liner 2. Further, a reinforcing layer 7 formed by winding a fiber member containing a curable resin for reinforcement is provided around the liner 2.

In the pressure vessel 1, at the center in a radial direction of each dome part 4, a groove 10 is formed, in which the mouth ring 6 is mounted from an outer side in an axial direction L. The groove 10 is formed in a concave shape (truncated conical shape) that is recessed toward an inner side in the axial direction of the liner 2. The mouth ring 6 is attached at the center in the radial direction D of the groove 10 with a collar member 5.

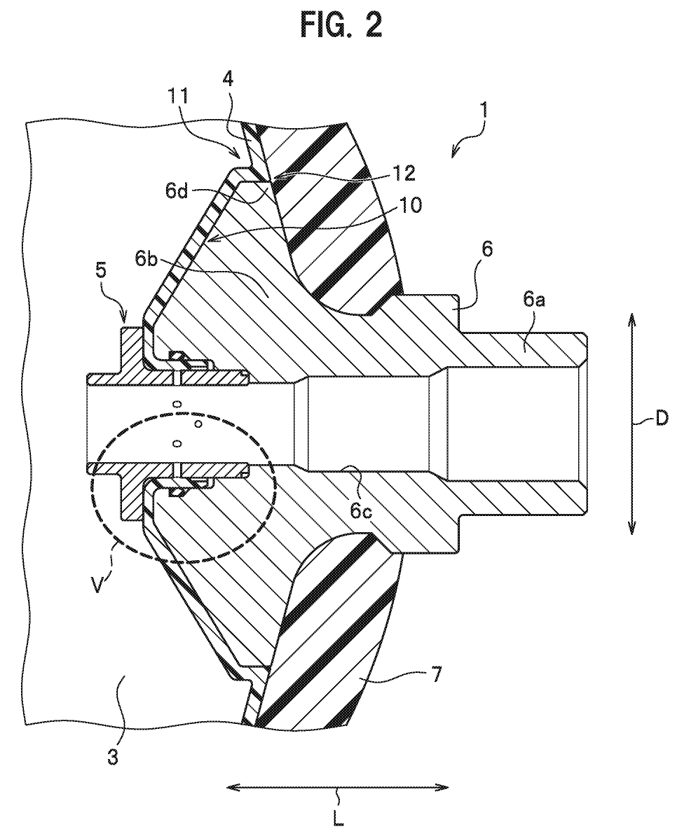

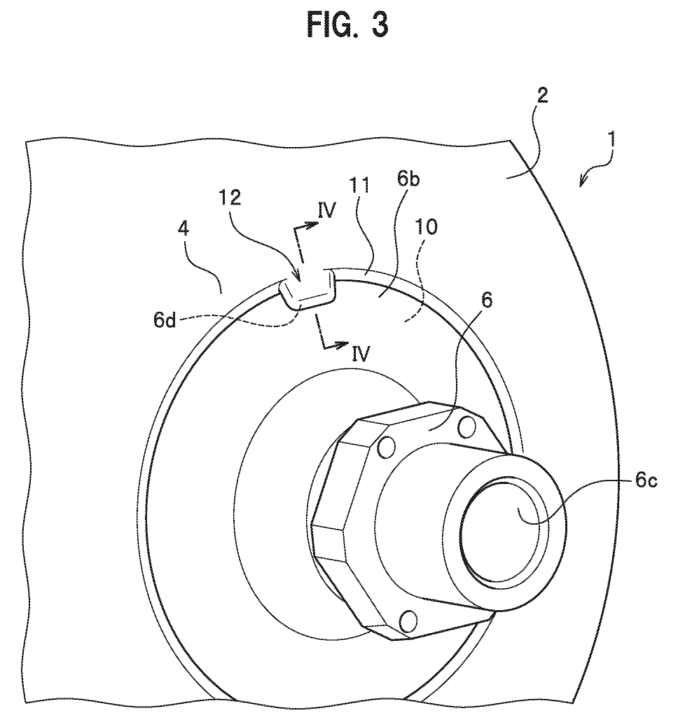

As shown in FIGS. 2 and 3, the mouth ring 6 has a boss 6a to which an external pipe is connected toward the outer side in the axial direction L, and a ring 6b having a disk shape which is continuous from the boss 6a and penetrates a pipe path 6c. At an outer peripheral edge of the ring 6b, a notch 6d of which at least a part thereof is notch-shaped is formed in a recessed manner. The ring 6b is formed in a truncated conical shape to be fitted into the groove 10.

Further, as shown in FIG. 2, in the pressure vessel 1, the collar member 5 as an inner support member for supporting the mouth ring 6 is disposed inside the groove 10 in the direction in which the storage part 3 is formed, that is, inside in the axial direction L.

FIG. 3 shows the pressure vessel 1 without the reinforcing layer 7. The liner 2 is provided with a locking part 12 for locking the mouth ring 6. The locking part 12 of the embodiment is formed to protrude from an annular connecting part 11 for connecting the dome part 4 and the groove 10.

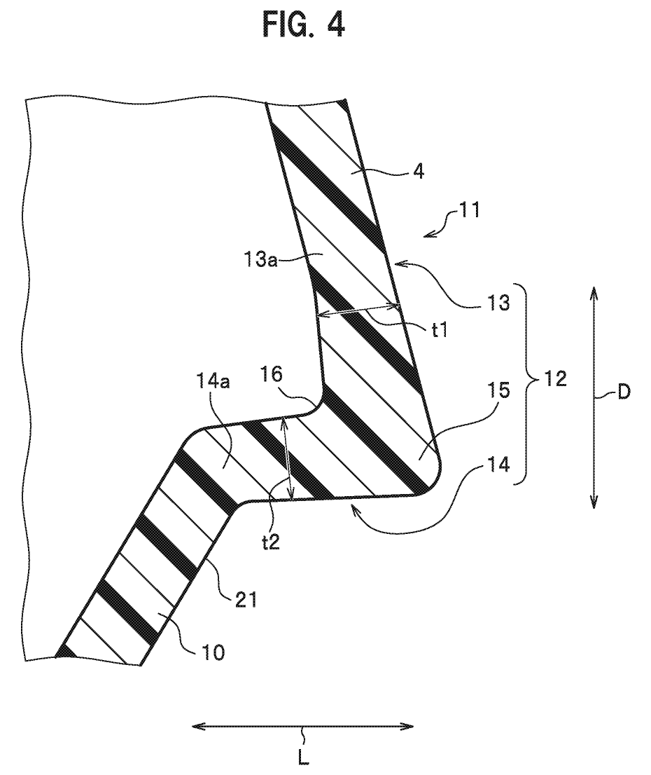

As shown in FIG. 4, the locking part 12 of the embodiment has a first wall 13 extending from the dome part 4 toward the center in a radial direction D, and a second wall 14 extending from the groove 10 toward the outer side in the axial direction L. Further, the locking part 12 has a top 15 where the first wall 13 and the second wall 14 are abutted against each other.

In the locking part 12 of the embodiment, a thickness t1 of the first wall 13 is increased from a dome-side base 13acontinuous to the dome part 4 toward the top 15. Further, in the locking part 12, a thickness t2 of the second wall 14 is increased from an inclined-side base 14a continuous to an inclined part 21 of the groove 10 toward the top 15. Still further, a lightening part 16 is provided on a back surface side of the top 15.

Therefore, the sectional thickness of the locking part 12 gradually changes, by which moldability when molding the liner 2 can be improved.

Further, when the mouth ring 6 is mounted in the groove 10 of the pressure vessel 1 (see FIG. 3), the locking part 12 is locked to the notch 6d formed in a recessed manner in the outer peripheral edge of the ring 6b of the mouth ring 6. This makes it possible to easily disable relative rotation between the mouth ring 6 and the liner 2 during assembly.

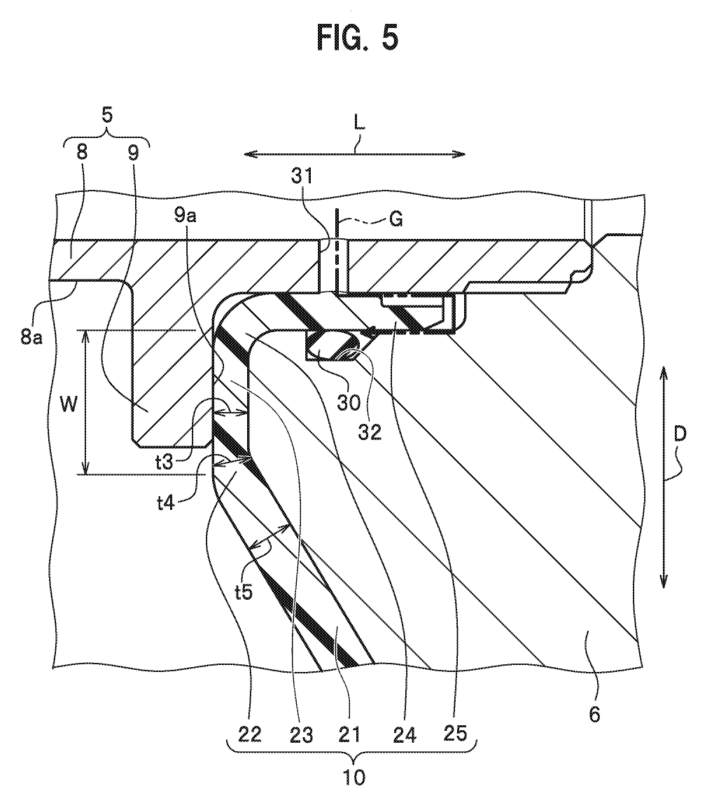

Further, as shown in FIG. 5, the groove 10 has the inclined part 21. The inclined part 21 is formed in a conical shape that descends inward in the axial direction L as extending inward in the radial direction D.

The groove 10 of the embodiment has a flat surface part 23 formed in an annular shape. The flat surface part 23 extends from a coupling part 22 located at a distal end of the inclined part 21 perpendicularly to the axial direction L (in the radial direction D). Further, the groove 10 has a cylindrical part 25 that extends from an inner peripheral edge 24 of the flat surface part 23 toward the outer side in the axial direction L.

The groove 10 is formed such that a thickness t3 of the flat surface part 23 and/or a thickness t4 of the coupling part 22 coupling the flat surface part 23 and the inclined part 21 are set to be thinner than a thickness t5 of the inclined part 21 (t3<t5, t4<t5). The coupling part 22 of the embodiment connects the flat surface part 23 and a tip of the inclined part 21 by bending in an R-shape at an angle smaller than 90 degrees. Further, in the embodiment, the thickness t3 of the flat surface part 23 and the thickness t4 of the coupling part 22 are set to have the same dimensions (t3=t4).

Further, the collar member 5 has an annular flange 9 on an outer wall surface 8a of a hollow shaft 8. The flange 9, having a flat outer surface 9a, extends from an outer wall surface 8a toward an outer side in the radial direction D. The outer surface 9a of the flange 9 is in contact with the flat surface part 23 of the groove 10 from an inner side in the axial direction L.

Further, in the pressure vessel 1 of the embodiment, a position of the coupling part 22 in the radial direction D is set outside the outer peripheral edge of the flange 9 of the collar member 5.

This allows a width dimension W of the flat surface part 23 in the radial direction D to be set large. Therefore, the thin flat surface part 23 and/or the coupling part 22 can be deformed more easily than the inclined part 21 and the connecting part 11 to absorb stress.

In the collar member 5 of the embodiment, a small hole 31 is formed in the outer wall surface 8a of the hollow shaft 8 so as to communicate an inner side and an outer side in the radial direction D. Accordingly, pressure applied by fluid G from both the inner and outer sides of the cylindrical part 25 in the radial direction D is equalized.

Further, an annular seal groove 32 is formed in a recessed manner at a position facing the cylindrical part 25 of an inner peripheral surface of the pipe path 6c of the mouth ring 6. An annular seal ring 30 is fitted in the seal groove 32. Thus, the seal ring 30 is brought into contact with the outer peripheral surface of the cylindrical part 25 formed in the groove 10 of the pressure vessel 1 in a state where the cylindrical part 25 is interposed between the hollow shaft 8 and the mouth ring 6. Therefore, the seal ring 30 seals between the cylindrical part 25 and the mouth ring 6.

In the pressure vessel structure of the embodiment, when the pressure vessel 1 is assembled, the hollow shaft 8 of the collar member 5 is inserted into the cylindrical part 25 of the groove 10 from the inside in the axial direction L. Next, the mouth ring 6, in which the seal ring 30 is fitted in the seal groove 32, is screwed onto a screw provided at a distal end of the hollow shaft 8 from the outside in the axial direction L. As a result, the cylindrical part 25 of the groove 10 is press-fitted between the mouth ring 6 and the outer wall surface 8a of the hollow shaft 8.

In the pressure vessel structure of the embodiment configured as described above, when the cylindrical part 25 is press-fitted between the mouth ring 6 and the outer wall surface 8a of the hollow shaft 8, the seal ring 30 is squashed between a bottom part of the seal groove 32 and the outer wall surface of the cylindrical part 25 in the radial direction D to seal between the mouth ring 6 and the cylindrical part 25.

Then, the fluid G such as hydrogen gas filled in the storage part 3 flows around between the mouth ring 6 and the cylindrical part 25 through the small hole 31 as shown by an imaginary line in FIG. 5. Accordingly, the pressure applied from both the inner and outer sides of the cylindrical part 25 in the radial direction D is equalized. Therefore, deformation or movement of the seal ring 30 or the liner 2 is reduced, and a desired sealing property is maintained, so that the risk of leakage of the fluid G can be eliminated.

Further, the stress generated by temperature decrease of the hydrogen gas or the like in the storage part 3 is absorbed by deformation of the flat surface part 23 and/or the coupling part 22 of the groove 10 having a small thickness. Therefore, displacement of the seal ring 30 can be further reduced, so that desired sealing characteristics can be maintained.

Specifically, as shown in FIG. 5, the cylindrical part 25 interposed between the inner peripheral surface formed with the seal groove 32 of the mouth ring 6 and the outer wall surface 8a of the hollow shaft 8 is press-fitted and prevented from coming off. In contrast, the flat surface part 23 and/or the coupling part 22 can be deformed outward in the axial direction L with respect to the outer surface 9a of the flange 9.

Therefore, the seal ring 30 in the seal groove 32 is squashed in the radial direction D between the bottom part and the outer wall surface of the cylindrical part 25, so as not to move in the axial direction L even when pressure fluctuation occurs. Therefore, the sealing property between the mouth ring 6 and the cylindrical part 25 can be maintained favorably.

As described above, the pressure vessel structure of the present invention includes the cylindrical liner 2 made of synthetic resin having the storage part 3 therein, and the mouth ring 6 provided at the end of the liner 2 in the axial direction L. The liner 2 includes the dome part 4 provided at the end of the liner 2 in the axial direction L, and the groove 10 formed in a recessed shape at the center of the dome part 4 in the radial direction D and in which the mouth ring 6 is provided. Further, the liner 2 includes the locking part 12 which is projected from the dome part 4 and the connecting part 11 of the groove 10 to lock the mouth ring 6. The locking part 12 includes the first wall 13 extending from the dome part 4 toward the center in the radial direction D, the second wall 14 extending from the groove 10 toward the outside in the axial direction L, and the top 15 where the first wall 13 and the second wall 14 abut against each other. The first wall 13 increases in thickness toward the top 15. Further, the second wall 14 increases in thickness toward the top 15. Still further, the lightening part 16 is provided on the back surface side of the top 15.

The pressure vessel structure of the present invention configured as described above can provide the pressure vessel 1 capable of improving flow disturbance and reducing plastic distortion.

Specifically, molten resin flowing along the first wall 13, the second wall 14, and the top 15 of the locking part 12 shown in FIG. 4 smoothly spreads to the top 15 where the first wall 13 and the second wall 14 are attached to each other. Therefore, even if the locking part 12 is provided to protrude from the connecting part 11, the flow disturbance can be improved.

For example, it is easily set such that a weld line is not formed on the locking part 12 due to the flow disturbance. This can suppress a decrease in strength of the locking part 12.

Further, the lightening part 16 can reduce the thickness of the top 15. Therefore, the temperature of the molten resin is made even when the molten resin is cooled. Accordingly, the locking part 12 can reduce the plastic distortion.

Thus, the strength of the locking part 12 is improved, and the locking part 12 is locked to the notch 6d which is recessed on the outer peripheral edge of the ring 6b in a state where the mouth ring 6 is provided in the groove 10 of the pressure vessel 1. Therefore, the relative rotation between the mouth ring 6 and the liner 2 can be prevented.

For example, the reinforcing layer 7 is formed by a filament winding (FW) method. In a manufacturing process by the FW method, the mouth ring 6 provided on the liner 2 is held by a rotating part of a winding machine (not shown). Then, the mouth ring 6 and the liner 2 are rotated by the winding machine, and a fiber member impregnated with liquid curable resin is wound around the liner 2 while a desired tensile force is applied to the fiber member. During the winding, a case is assumed where the liner 2 is detached from the mouth ring 6 and only the mouth ring 6 is rotated.

In the pressure vessel structure of the embodiment, the locking part 12 of the liner 2 is locked to the notch 6d recessed in the outer peripheral edge of the ring 6b of the mouth ring 6, which prevents the relative rotation between the mouth ring 6 and the liner 2. Therefore, even when the tensile force is applied to the fiber member, the liner 2 rotates together with the mouth ring 6. Therefore, the fiber member can be wound around the liner 2 at a high speed, which reduces manufacturing cost.

Further, a claw locking structure by the locking part 12 and the notch 6d is used between the liner 2 and the mouth ring 6. Therefore, as compared with a screw fitting structure, processing is easy and assembly is improved. In addition, degree of freedom of shape design is improved. This reduces the manufacturing cost of the pressure vessel 1.

Further, the groove 10 includes the inclined part 21 that descends inward in the axial direction L as extending inward in the radial direction D, and the flat surface part 23 that is formed in an annular shape extending perpendicularly to the axial direction L from a tip end of the inclined part 21. Also, the groove 10 includes the cylindrical part 25 that rises from the inner peripheral edge 24 of the flat surface part 23 toward outside in the axial direction L. Then, The collar member 5 as an inner support member that supports the mouth ring 6 is disposed inside the cylindrical part 25. Note that a gate part for injection molding in the liner 2 may be provided on an inner peripheral side or an outer peripheral side of the cylindrical part 25.

The collar member 5 has the flange 9 that extends annularly outward in the radial direction D to come into contact with the flat surface part 23. The thickness t3 and/or the thickness t4 of the coupling part 22 that connects the flat surface part 23 and the inclined part 21 are/is set thinner than the thickness t5 of the inclined part 21.

Therefore, the thin flat surface part 23 and/or the coupling part 22 are deformed earlier than the dome part 4 due to an internal pressure fluctuation of the storage part 3 to absorb stress. Therefore, an amount of deformation of a part of the liner 2 that is continuous from the dome part 4 to the connecting part 11 of the groove 10, where the stress is high, can be reduced.

Further, the flat surface part 23 and the coupling part 22 have the thicknesses t3 and t4, respectively, which are thinner than the thickness t5 of the inclined part 21. Therefore, the flat surface part 23 is formed in a plate spring shape, and can be easily deformed to be close and away from the outer surface 9a in the axial direction L.

When the temperature is lowered, the flat surface part 23 is brought into vertical surface contact with the outer surface 9a by stress acting toward an inner side in the axial direction L. The connecting part 22 located on an outer side in the radial direction D with respect to the outer peripheral edge of the flange 9 is easily deformed toward an outer side in the axial direction L. Therefore, the flat surface part 23 and the connecting part 22 can effectively absorb the stress before the dome part 4. Note that the radially outer end of the flange 9 is preferably located radially inward of the coupling part 22.

Further, the reinforcing layer 7 formed by winding a fiber member containing a curable resin is provided around the liner 2.

Thus, the reinforcing layer 7 around the liner 2 is not deformed due to the decrease of the outside air temperature or the decrease of the temperature of the hydrogen gas, the natural gas or the like filled in the storage part 3. Therefore, the stress due to the temperature decrease acts inward in the axial direction L around the dome part 4 and/or the connecting part 11 connecting the dome part 4 and the groove 10.

However, the flat part 23 and/or the coupling part 22 of the thin groove 10 can be deformed earlier than the dome part 4 and the connecting part 11 of the groove 10 to absorb the stress. Therefore, it is possible to alleviate the stress that pulls the vicinity of the connecting part 11 toward the inside in the axial direction L.

Therefore, the pressure vessel structure of the present invention exhibits practically useful effects to alleviate high stress.

The present invention is not limited to the above-described embodiment, and various modifications can be made. The above-described embodiment is an example for easy understanding of the present invention, and the present invention is not necessarily limited to those having all the configurations described above. In addition, a part of the configuration of a certain embodiment can be replaced with the configuration of another embodiment, and the configuration of another embodiment can be added to the configuration of a certain embodiment. Further, a part of the configuration of each embodiment may be deleted, or another configuration may be added or replaced. Possible modifications of the above embodiment are, for example, as follows.

The locking part 12 of the embodiment is provided to protrude from the annular connecting part 11 connecting the dome part 4 and the groove 10. However, the present invention is not particularly limited thereto. For example, the number of locking part 12 and notch part 6d on the mouth ring 6 side to which the locking part 12 is locked may be one or two or more, and the shapes, the numbers, the materials, and the like of the locking part 12 and the notch part 6d are not particularly limited.

What is claimed is:

1. A pressure vessel structure comprising: a cylindrical synthetic resin liner having a reservoir part therein; and a mouth ring provided at an end in an axial direction of the liner;
the liner includes:
a dome part provided at the end in the axial direction of the liner;
a groove formed in a concave shape at a center in a radial direction of the dome part to which the mouth ring is mounted; and
a locking part that is provided to protrude from a connecting part between the dome part and the groove to lock the mouth ring; wherein
the locking part includes a first wall extending from the dome part toward a center in the radial direction, a second wall extending from the groove toward an outer side in the axial direction, and a top where the first wall and the second wall are abutted against each other, and
the first wall has a thickness that increases toward the top, and the second wall has a thickness that increases toward the top to provide a lightening part on a back surface side of the top.

2. The pressure vessel structure according to claim 1, wherein the groove includes:
an inclined part that descends axially inward as extending radially inward;
a flat surface part formed in an annular shape extending from an end of the inclined part perpendicularly to the axial direction; and
a cylindrical part that rises from an inner circumferential edge of the flat surface part toward an outer side in the axial direction; wherein
an inner support member that supports the mouth ring is disposed inside the cylindrical part;
the inner support member includes a flange that extends annularly outward in the radial direction to be brought in contact with the flat surface part; and
a thickness of the flat surface part and/or a thickness of a coupling part to couple the flat surface part and the inclined part are set to be thinner than a thickness of the inclined part.

3. The pressure vessel structure according to claim 2, further comprising a reinforcing layer formed by winding a fiber member containing a curable resin around the liner.

4. The pressure vessel structure according to claim 2, wherein a radially outer end of the flange is located radially inward of the coupling part.
